(19) United States
(12) Patent Application Publication
(10) Pub. No.: US 2004/0139029 A1
(43) Pub. Date: Jul. 15, 2004

(54) Apparatus and method for generating and verifying ID-based blind signature by using bilinear parings

(75) Inventors: Fangguo Zhang, Daejeon (KR); Kwangjo Kim, Daejeon (KR)

Correspondence Address: BACON & THOMAS, PLLC, 625 SLATERS LANE, FOURTH FLOOR, ALEXANDRIA, VA, 22314

(73) Assignee: Information And Communications University Educational Foundation, Seoul (KR)

(21) Appl. No.: 10/699,643

(22) Filed: Nov. 4, 2003

(30) Foreign Application Priority Data
Dec. 24, 2002 (KR) 10-2002-0083112

(51) Int. Cl. G06F 17/60

(52) U.S. Cl. 705/74

(57) ABSTRACT

In an apparatus and a method for generating and verifying an identity based blind signature by using bilinear parings, a trust authority generates system parameters and selects a master key. Further, the trust authority generates a private key by using a signer's identity and the master key. The signer computes a commitment and sends the commitment to the user. The user blinds a message and sends the blinded message to the signer. The signer signs the blinded message and sends the signed message to the user. Thereafter, the user unblinds the signed message and then verifies the signature.

### FIELD OF THE INVENTION

The present invention relates to a cryptographic system; and, more particularly, to an apparatus and a method for generating and verifying an identity (ID) based blind signature by using bilinear parings.

### BACKGROUND OF THE INVENTION

In a public key cryptosystem, each user may have two keys, i.e., a private key and a public key. A binding between the public key (PK) and the identity (ID) of a user is obtained via a digital certificate. However, in such a certificate-based public key system, before using the public key of the user, a participant must verify the certificate of the user at first. As a consequence, this system demands a large amount of computing time and storage because it is required to store and verify each user's public key and the corresponding certificate.

In 1984, Shamir (A. Shamir, “Identity-based cryptosystems and signature schemes”, Advances in Cryptology-Crypto 84, LNCS 196, pp.47-53, Springer-Verlag, 1984.) published ID-based encryption and signature schemes to simplify key management procedures in a certificate-based public key setting. Since then, many ID-based encryption schemes and signature schemes have been proposed. The main idea of ID-based cryptosystems is that the identity information of each user works as his/her public key, in other words, the user's public key can be calculated directly from his/her identity rather than being extracted from a certificate issued by a certificate authority (CA).

Therefore, the ID-based public key setting need not perform following processes needed in the certificate-based public key setting: transmission of certificates, verification of certificates and the like. The ID-based public key setting can be an alternative to the certificate-based public key setting, especially when efficient key management and moderate security are required.

The bilinear pairings, namely the Weil pairing and the Tate pairing of algebraic curves, are important tools for research on algebraic geometry. Early applications of the bilinear pairings in cryptography were made to resolve discrete logarithm problems. For example, the MOV (Meneze-Okamoto-Vanstone) attack (using the Weil pairing) and FR (Frey-Ruck) attack (using the Tate pairing) reduce the discrete logarithm problems on certain elliptic or hyperelliptic curves to the discrete logarithm problems in a finite field. Recently, the bilinear pairings have found various applications in cryptography as well.

Specifically, the bilinear parings are basic tools to construct the ID-based cryptographic schemes and many ID-based cryptographic schemes have been proposed by using them. Examples of using the bilinear pairings in ID-based cryptographic schemes include: Boneh-Franklin's ID-based encryption scheme (D. Boneh and M. Franklin, “Identity-based encryption from the Weil pairing”, Advances in Cryptology-Crypto 2001, LNCS 2139, pp.213-229, Springer-Verlag, 2001.), Smart's ID-based authentication key agreement protocol (N.P. Smart, “Identity-based authenticated key agreement protocol based on Weil pairing”, Electron. Lett., Vol.38, No.13, pp.630-632, 2002.), and several ID-based signature schemes.

In a public key setting, the user information can be protected by means of a blind signature. The idea of using blind signatures was introduced by Chaum (D. Chaum, “Blind signatures for untraceable payments”, Advances in Cryptology Crypto 82, Plenum, NY, pp.199-203, 1983.), whose idea was to provide anonymity of users in such applications as electronic voting and electronic payment systems. A blind signature scheme is an interactive two party protocol between a user and a signer. In contrast to regular signature schemes, the blind signature scheme allows the user to obtain a signature of a message with the signer not knowing the contents of the message. The blind signature scheme plays a central role in constructing anonymous electronic cash systems.

Several ID-based signature schemes based on the bilinear pairings have been developed recently. On the other hand, ID-based blind signature system using the bilinear parings has not been yet proposed. An ID-based blind signature is attractive since one's public key is simply one's identity. For example, if a bank issues electronic cash with an ID-based blind signature, users and shops need not fetch the bank's public key from a database. They can verify the electronic cash only by the following information: “Name of Country”, “Name of City”, “Name of Bank” and “this year”.

### SUMMARY OF THE INVENTION

It is, therefore, an object of the present invention to provide a method and an apparatus for generating and verifying an identity based blind signature by using bilinear parings, which reduces the amount of computing time and storage and simplifies the key management procedures.

In accordance with one aspect of the present invention, there is provided a method for generating and verifying an ID-based blind signature by using bilinear parings, comprising the steps of: generating system parameters, selecting a master key, and then disclosing the system parameters by a trust authority; generating a private key by using a signer's identity and the master key, and then transferring the private key to the signer through a secure channel by the trust authority; receiving and storing the system parameters by a user and receiving and storing the system parameters and the private key by the signer; computing a commitment by using at least one of the system parameters, and then sending the commitment to the user by the signer; blinding a message by using the commitment and a public key based on the signer's identity, and then sending the blinded message to the signer by the user; signing the blinded message by using the private key, and then sending the signed message to the user by the signer; unblinding the signed message by the user; and verifying the signature by the user.

In accordance with another aspect of the present invention, there is provided an apparatus for generating and verifying an ID-based blind signature by using bilinear parings, comprising: means for generating system parameters, selecting a master key, and then disclosing the system parameters by a trust authority; means for generating a private key by using a signer's identity and the master key, and then transferring the private key to the signer through a secure channel by the trust authority; means for receiving and storing the system parameters by a user and receiving and storing the system parameters and the private key by the signer; means for computing a commitment by using at least one of the system parameters, and then sending the commitment to the user by the signer; means for blinding a message by using the commitment and a public key based on the signer's identity, and then sending the blinded message to the signer by the user; means for signing the blinded message by using the private key, and then sending the signed message to the user by the signer; means for unblinding the signed message by the user; and means for verifying the signature by the user.

### BRIEF DESCRIPTION OF THE DRAWINGS

The above and other objects and features of the present invention will become apparent from the following description of preferred embodiments given in conjunction with the accompanying drawings, in which:

FIG. 1A shows a block diagram illustrating an interaction among participants of a blind signature system in accordance with the present invention;

FIG. 1B is a block diagram illustrating a process for generating and verifying a blind signature in accordance with the present invention; and

FIG. 2 describes a flow chart showing an operation of the system for generating and verifying an ID-based blind signature by using bilinear parings in accordance with a preferred embodiment of the present invention.

### DETAILED DESCRIPTION OF THE PREFERRED EMBODIMENTS

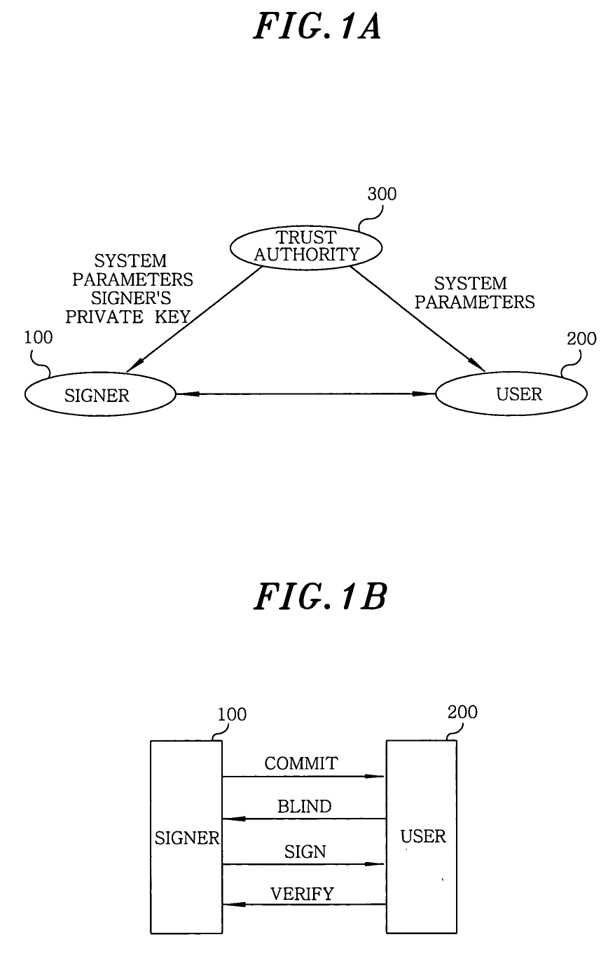

FIG. 1A illustrates an interaction among participants of a blind signature system in accordance with the present invention. The system includes three participants, i.e., a signer 100, a user 200 and a trust authority 300. Herein, each of participants of the system may be a computer system and may communicate with another remotely by using any kind of communications network or other techniques. The information to be transferred between the participants may be stored and/or held in various types of storage media.

The trust authority 300 generates system parameters and selects a master key. Further, the trust authority 300 generates a private key by using the signer's identity and the master key. Then, the trust authority 300 discloses or publishes the system parameters and transfers the private key to the signer 100 through a secure channel.

The user 200 receives the system parameters which the trust authority 300 provides. Then, the user 200 stores or holds them in a storage media.

Meanwhile, the signer 100 receives the system parameters and the private key which the trust authority 300 provides. Then, the signer 100 stores or holds them in a storage media.

Referring to FIG. 1B, a process for generating and verifying a blind signature between the signer 100 and the user 200 is shown. The signer 100 computes a commitment by using at least one of the system parameters and sends the commitment to the user 200. Thereafter, the user 200 blinds a message to be signed by using the commitment and a public key, which is generated by using the signer's identity, and sends the blinded message to the signer 100. Then, the signer 100 computes a signed value of the message by using the private key and sends it back to the user 200 without knowing the contents of the message. Finally, the user 200 receives the signed message from the signer 100 and verifies the signature.

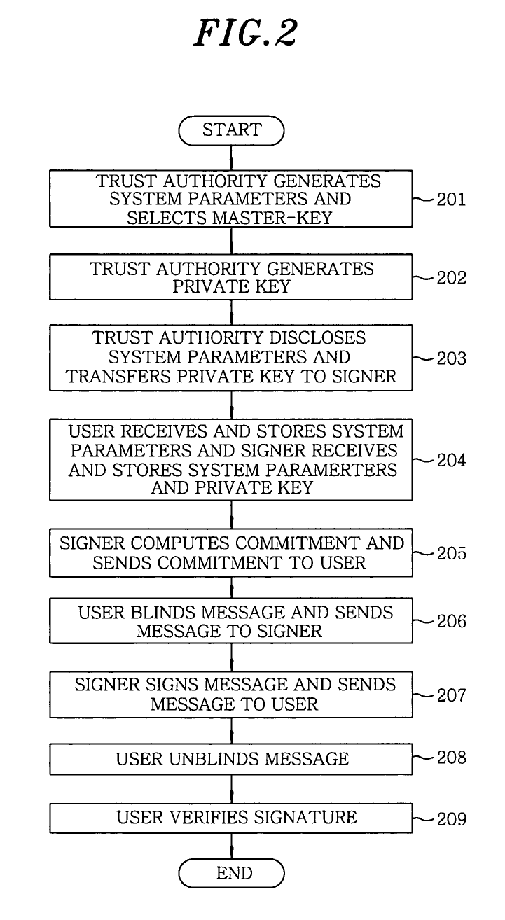

Referring now to FIG. 2, a detailed description on a method for generating and verifying an ID-based blind signature by using bilinear parings in accordance with a preferred embodiment of the present invention will be presented.

Let G be a cyclic group generated by P, whose order is a prime q, and V be a cyclic multiplicative group of the same order q. Discrete logarithm problems in both G and V are considered to be hard. Let e: G×G→V be a pairing that satisfies following conditions:

1. Bilinear: e(P₁+P₂, Q)=e(P₁, Q)e(P₂, Q) and e(P, Q₁+Q₂)=e(P, Q₁)e(P, Q₂) or e(aP, bQ)=e(P, Q)^{ab};

2. Non-degenerate: There exists PεG and QεG such that e(P, Q)≠1; and

3. Computability: There is an efficient algorithm to compute e(P, Q) for all P, QεG.

During a process of generating system parameters and selecting a master key (step 201), which is performed by the trust authority 300, the cyclic groups G and V, order of each of them being q, are generated. Then P (the generator of G) and e: G×G→V (a pairing of the two cyclic groups G and V) are generated. In the present invention, G is an elliptic curve group or hyperelliptic curve Jacobians and V uses cyclic multiplicative group Z_{q}*. Then, the trust authority 300 selects an integer s belonging to Z_{q}* as a master key and computes P_{pub}=s·P. Additionally, the trust authority 300 selects hash functions H: {0,1}*→Z_{q}* and H₁: {0,1}*→G.

Thereafter, the trust authority 300 generates a private key by using the signer's identity and the master key (step 202). Given the signer's identity ID, which implies the public key Q_{ID}=H₁(ID), the trust authority 300 returns the private key S_{ID}=s·Q_{ID}. It should be noted that the trust authority 300 can have access to the sensitive private key S_{ID}: To avoid power abuse by the trust authority 300, n trust authorities with a (n, n)-threshold secret sharing scheme may be used to escrow the master key.

The trust authority 300 discloses or publishes the system parameters. More precisely, the trust authority 300 publishes <G, q, P, P_{pub}, H, H₁> as the system parameters that the signer 100 and the user 200 may share. Further, the trust authority 300 transfers the private key to the signer 100 through a secure channel (step 203).

The user 200 receives and stores the system parameters while the signer 100 receives and stores the system parameters and the private key (step 204).

During a process of the blind signature, the signer 100 randomly chooses a number rεZ_{q}*, computes R=r·P, and sends R to the user 200 as a commitment (step 205).

Thereafter, the user 200 randomly chooses a, bεZ_{q}* as blinding factors. The user 200 computes a blinded message c described by c=H(m, e(b·Q_{ID}+R+a·P, P_{pub}))+b (mod q), where m is a message to be signed. Then the user 200 sends c to the signer 100 (step 206).

Thereafter, the signer 100 sends back a signed message S described by S=c·S_{ID}+r·P_{pub} (step 207).

Thereafter, the user 200 computes S′=S+a·P_{pub} and c′=c−b by using the blinding factors the user 200 chose, and outputs (m, S′, c′) (step 208). Then, (S′, c′) is the blind signature of the message m.

During a process of verification (step 209), the user 200 makes use of the message m, the system parameters and the signer's public key Q_{ID} that the trust authority 300 disclosed. The signature is acceptable if and only if c′=H(m, e(S′, P)·e(Q_{ID}, P_{pub})^{-c′}. The verification of the signature is justified by employing the following equations:

$$H ( m , ⅇ ( {S}^{′} , P ) \cdot {ⅇ ( {Q}_{ID ,} {P}_{pub} )}^{- {c}^{′}} ) = H ( m , ⅇ ( S + {aP}_{pub ,} P ) \cdot {ⅇ ( {Q}_{ID ,} {P}_{pub} )}^{- {c}^{′}} ) = H ( m , ⅇ ( {cS}_{ID} + {rP}_{pub} + {aP}_{pub ,} P ) \cdot {ⅇ ( {Q}_{ID ,} {P}_{pub} )}^{- {c}^{′}} ) = H ( m , ⅇ ( {cS}_{ID ,} P ) \cdot e ( {rP}_{pub} + {aP}_{pub ,} P ) \cdot {ⅇ ( {Q}_{ID ,} {P}_{pub} )}^{- {c}^{′}} ) = H ( m , {ⅇ ( {S}_{ID ,} P )}^{c} \cdot e ( ( r + a ) {P}_{pub ,} P ) \cdot {ⅇ ( {Q}_{ID ,} {P}_{pub} )}^{- {c}^{′}} ) = H ( m , {ⅇ ( {Q}_{ID ,} {P}_{pub} )}^{c} \cdot e ( ( r + a ) P , {P}_{pub} ) \cdot {ⅇ ( {Q}_{ID ,} {P}_{pub} )}^{- {c}^{′}} ) = H ( m , {ⅇ ( {Q}_{ID ,} {P}_{pub} )}^{c - c ′} \cdot e ( R + a P , {P}_{pub} ) ) = H ( m , {ⅇ ( {Q}_{ID ,} {P}_{pub} )}^{b} \cdot e ( R + a P , {P}_{pub} ) ) = H ( m , ⅇ ( {bQ}_{ID ,} + R + a P , {P}_{pub} ) ) = c - b = {c}^{′} .$$

As describe above, the ID-based blind signature scheme of the present invention is considered as a combination of a general blind signature scheme and an ID-based one. In other words, it is a kind of blind signature but its public key for verification is just the signer's identity.

The ID-based blind signature scheme can be performed with supersingular elliptic curves or hyperelliptic curves. The essential operation in the ID-based signature schemes is to compute a bilinear pairing. The computation of a bilinear pairing may be performed efficiently and the length of a signature can be reduced by using compression techniques.

Since the scheme of the present invention is based on an identity rather than an arbitrary number, a public key includes one's information, e.g., an email address, that may uniquely identify oneself. In some applications, the lengths of public keys and signatures can be reduced. For instance, in an electronic voting or an electronic auction system, the registration manager (RM) can play the role of the trust authority. In the registration phase, RM gives a bidder or a voter his registration number as his public key={(The name of the e-voting or e-auction system∥RM∥Date∥Number), n}. Here, n is the number of all bidders or voters.

Further, the blind signature of the present invention provides the user's anonymity and non-forgeability. To produce a blind signature, the signer is only required to compute three scalar multiplications in G, while the user is required three scalar multiplications in G, one hash function evaluation and one bilinear pairing computation. The verification operation requires one hash function evaluation, two bilinear pairing computations and one exponentiation in V. One pairing computation can be saved by precomputing e(Q_{ID}, P_{pub}), if a large number of verifications are to be performed for the same identity. The signature includes an element in G and an element in V. In practice, the size of the element in G (elliptic curve group or hyperelliptic curve Jacobians) can be reduced by using compression techniques.

The above-described system for generating and verifying an ID-based blind signature by using bilinear parings in accordance with the present invention may reduce the amount of computing time and storage and simplify the key management procedures because processes needed in the certificate-based public key setting, i.e., transmission of certificates, verification of certificates and the like, are not needed.

While the invention has been shown and described with respect to the preferred embodiments, it will be understood by those skilled in the art that various changes and modifications may be made without departing from the spirit and scope of the invention as defined in the following claims.

What is claimed is:

1. A method for generating and verifying an ID-based blind signature by using bilinear parings, comprising the steps of:
generating system parameters, selecting a master key, and then disclosing the system parameters by a trust authority;
generating a private key by using a signer's identity and the master key, and then transferring the private key to the signer through a secure channel by the trust authority;
receiving and storing the system parameters by a user and receiving and storing the system parameters and the private key by the signer;
computing a commitment by using at least one of the system parameters, and then sending the commitment to the user by the signer;
blinding a message by using the commitment and a public key based on the signer's identity, and then sending the blinded message to the signer by the user;
signing the blinded message by using the private key, and then sending the signed message to the user by the signer;
unblinding the signed message by the user; and
verifying the signature by the user.

2. The method of claim 1, wherein the system parameters include G, q, P, P_{pub}, H and H₁, where G is a cyclic group, q is G's order, P is a generator of G, P_{pub} is the trust authority's public key described by P_{pub}=S P, where s is the master key, and H and H₁ are hash functions, respectively, described by H: {0,1}*→Z_{q}* and H₁: {0,1}*→G, where Z_{q}* is a cyclic multiplicative group; and
the bilinear paring e is defined by e: G×G→V, where V is a cyclic multiplicative group of the order q and uses the cyclic multiplicative group Z_{q}*.

3. The method of claim 2, wherein the public key Q_{ID} is described by Q_{ID}=H₁(ID), where ID is the signer's identity, and the private key S_{ID} is described by S_{ID}=S Q_{ID}.

4. The method of claim 3, wherein the commitment R is described by R=r·P, where r is a random number the signer chooses.

5. The method of claim 4, wherein the blinded message c is described by c=H(m, e(b·Q_{ID}+R+a·P, P_{pub}))+b(mod q), where m is a message to be sent and a and b are blinding factors belonging to Z_{q}*.

6. The method of claim 5, wherein the signed message is described by S=c·S_{ID}+r·P_{pub}.

7. The method of claim 6, wherein the step of unblinding is performed by using formula S′=S+a·P_{pub} and c′=c−b.

8. The method of claim 7, wherein the step of verifying is performed by using following equations:
H(m,e(S′,P)·e(Q_{ID},P_{pub})^{-c′})=c′.

9. An apparatus for generating and verifying an identity-based blind signature by using bilinear parings, comprising:
means for generating system parameters, selecting a master key, and then disclosing the system parameters by a trust authority;
means for generating a private key by using a signer's identity and the master key, and then transferring the private key to the signer through a secure channel by the trust authority;
means for receiving and storing the system parameters by a user and receiving and storing the system parameters and the private key by the signer;
means for computing a commitment by using at least one of the system parameters, and then sending the commitment to the user by the signer;
means for blinding a message by using the commitment and a public key based on the signer's identity, and then sending the blinded message to the signer by the user;
means for signing the blinded message by using the private key, and then sending the signed message to the user by the signer;
means for unblinding the signed message by the user; and
means for verifying the signature by the user.

10. The apparatus of claim 9, wherein the system parameters include G, q, P, P_{pub}, H and H₁, where G is a cyclic group, q is G's order, P is a generator of G, P_{pub} is the trust authority's public key described by P_{pub}=s·P, where s is the master key, and H and H₁ are hash functions, respectively, described by H: {0,1}*→Z_{q}* and H₁: {0,1}*→G, where Z_{q}* is a cyclic multiplicative group; and
the bilinear paring e is defined by e: G×G→V, where V is a cyclic multiplicative group of the order q and uses the cyclic multiplicative group Z_{q}*.

11. The apparatus of claim 10, wherein the public key Q_{ID} is described by Q_{ID}=H₁(ID), where ID is the signer's identity, and the private key S_{ID} is described by S_{ID}=s·Q_{ID}.

12. The apparatus of claim 11, wherein the commitment R is described by R=r·P, where r is a random number the signer chooses.

13. The apparatus of claim 12, wherein the blinded message c is described by c=H(m, e(b·Q_{ID}+R+a·P, P_{pub}))+b(mod q), where m is a message to be sent and a and b are blinding factors belonging to Z_{q}*.

14. The apparatus of claim 13, wherein the signed message is described by S=c·S_{ID}+r·P_{pub}.

15. The apparatus of claim 14, wherein the means for unblinding unblinds the signed message by using formula S′=S+a·P_{pub} and c′=c−b.

16. The apparatus of claim 15, wherein the means for verifying verifies the signature by using following equations:
H(m,e(S′,P)·e(Q_{ID},P_{pub})^{-c′})=c′.
